(19) United States
(12) Patent Application Publication
(10) Pub. No.: US 2012/0098480 A1
(43) Pub. Date: Apr. 26, 2012

(54) SOLAR BATTERY CHARGING SYSTEM FOR ELECTRIC AND/OR HYBRID AUTOMOBILES

(76) Inventor: Sean R. David, Jersey City, NJ (US)

(21) Appl. No.: 13/274,490

(22) Filed: Oct. 17, 2011

Related U.S. Application Data
(60) Provisional application No. 61/405,583, filed on Oct. 21, 2010.

(51) Int. Cl. H01M 10/46

(52) U.S. Cl. 320/101; 320/107

(57) ABSTRACT

A solar powered battery charging system for an existing hybrid or electric vehicle is provided. The system includes a photovoltaic panel attachable to a vehicle and connectable to a battery apparatus of the vehicle. The vehicle may be attached to an electric utility power grid to provide excess energy in the form of electricity to the power grid.

### BACKGROUND OF THE INVENTION

The auto industry has put its hopes, dreams, and capital into a multimillion dollar product: electric battery powered vehicles. More than twenty electric model vehicles are set to arrive at dealerships during a three year time frame (2010-2013). The Chevrolet Volt and the Nissan Leaf are set to launch by the end of 2010. Many experts have declared the following to be the main drawbacks of owning an electric/hybrid vehicle:
   Electric/hybrid vehicles are too expensive;
   Electric/hybrid vehicles do not provide enough driving range before they run out of battery power;
   Electric/hybrid vehicles take too long to recharge; and
   Electric/hybrid vehicles are not completely environmental friendly because they are recharged by electricity produced by coal and gas-fired power plants.

### BRIEF DESCRIPTION OF THE DRAWINGS

FIG. 1 provides a diagram of an embodiment of the battery charging system of the present invention.

### SUMMARY OF THE INVENTION

The drawbacks listed above and other disadvantages possessed by the electric automobile have lead to the present invention: Solar Battery Charging System for Electric/Hybrid Automobiles.

This invention is a vehicle battery charging system/apparatus that generates power from the sun and harnesses that power to produce electricity through solar photovoltaic panels located throughout the body of the automobile or vehicle.

The environmentally friendly source of energy from the sun provides electric/hybrid vehicles with a sustainable source of battery power.

Hybrid electric automobile driving standards for voltage are normally in the range of 200-300 volts of electricity for primary and secondary batteries. The battery charge for the electric hybrid fuel battery is 24-96 volts with the normal voltage being 48. The control method for voltage in the electric vehicle is determined by the vehicle's possession of a conventional hybrid battery. The structure of the solar battery charging system of this present invention is directed to a photovoltaic panel located on the hood and throughout the vehicle body which permits the solar energy canisters such as batteries within the battery apparatus to be charged, resulting in several benefits. These benefits include extending the range of the electric vehicle because the batteries are charged during driving and during any occasion with direct sunlight. The cost of using electricity from a utility company to charge the vehicles is reduced because the batteries are typically at least partially charged by the solar charging during use.

The battery life of the vehicle can be extended because the depth of discharge can be reduced during normal use of the vehicle. By increasing the number of electric battery canisters which harvest solar energy (there may be 3-6 of these canisters present within the vehicle) will enhance the length of time required between charges, labor costs incurred in the process of charging the batteries are reduced. Vehicles can be used more efficiently, thus possibly reducing world oil consumption and electric vehicle battery charging from residential and commercial hybrid/electric vehicle charging docks.

One aspect of the invention relates to a vehicle such as an electric or hybrid vehicle and photovoltaic (PV) charging system in which the photovoltaic panel is attached on an upper part of the vehicle hood. The hood of the vehicle will possess several solar energy cells, the ratio of PV cells to the number of battery cells being between (a) about 4.85 to 5.55 PV cells to battery cells, and more preferably about 5.25 to 5.46 PV cells to battery cells. In one embodiment, the PV assembly comprises at least one of crystalline and poly-crystalline photovoltaic panel.

Another aspect of the invention relates to a hybrid or electric vehicle and PV charging system in which a graphical display is transferred to the vehicle smart computer (dashboard tool found in all modern vehicles) to inform the driver of the energy production, pollution avoidance, battery state of charge, and/or other informative parameters related to the operation of the invention.

### DETAILED DESCRIPTION OF THE PREFERRED EMBODIMENT

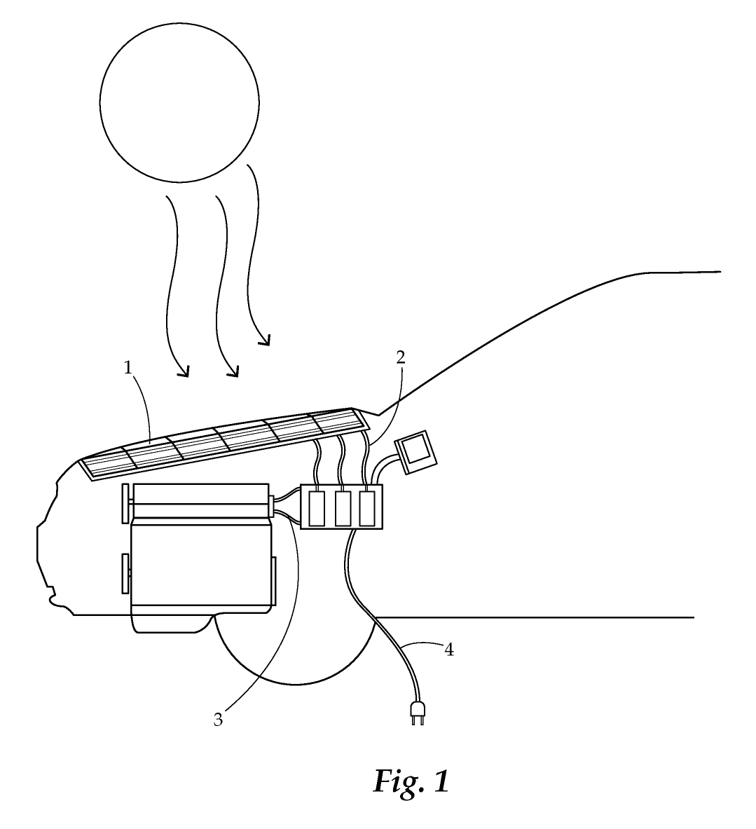

Referring to FIG. 1, an embodiment of a solar battery charging system is shown. Elements 1-4 provide features as follows:
Element 1 shows that the sun produces solar energy which is cultivated within solar photovoltaic panels to create clean energy.
Element 2 shows that the clean energy is transferred from the solar photovoltaic panels through high voltage direct current cables into a lithium ion battery apparatus containing multiple individual energy canisters. Each individual energy canister will have its own individual net metering system that will report its battery life into the vehicle's smart computer controlled by the vehicle owner (this computer system will let the vehicle owner know how much battery life each individual energy canister possesses).
Element 3 shows that the net metering system/smart computer will transfer clean energy from each individual energy canister through high voltage direct current cables into a hybrid/electric automobile motor.
Element 4 shows that the net metering system/smart computer will transfer excess clean energy to the vehicle owner's preferred utility company smart grid sub-station(s) through a high voltage direct current cable. The transfer of excess clean energy will off set the vehicle owner's monthly utility costs.

In further embodiments, the system and vehicle may include additional features. For example, in one embodiment, they system may comprise a regulator for providing substantially constant and regulated voltage power and conditioning the power for application to a battery of the vehicle to be charged from the solar energy provided by the PV panel. It should be understood that the term substantially constant voltage allows for the voltage to be adjusted periodically. In one embodiment, the solar energy provided by the PV panel is in the form of alternating current electricity.

A controller may be coupled electronically to the regulator and may further control the regulator as well as controlling and optimizing other battery charging functions. In another embodiment, the controller may further comprise a compensator which may be configured to adjust a total recharged ampere-hours of a battery by an amount determined from the age of the battery.

In a further embodiment, the controller may track the number of occurrences of recharge of the battery and the accumulated ampere-hours, and may apply an equalizing charge to the battery after a predetermined number of recharge occurrences and accumulated ampere-hours since a last equalizing charge.

Still further, the controller may compensate battery charging as a function of battery age. The controller may comprise a sensor to sense discharge current of the battery apparatus as a function of time, and the controller may compute, from the sensed discharge current and time duration of discharge, the net ampere-hours discharged by the battery. The controller may then recharge the battery until at least the computed net ampere-hours of discharge is returned to the battery. In a further embodiment, the controller may overcharge the battery.

The rate of battery recharge may be constant, or may vary. In one embodiment the rate of battery recharge may be constant until battery voltage equals a selected voltage limit, and thereafter is variable until the net ampere-hours of discharge has been returned. In a further embodiment, this variable amount may be in the range of about 2% to 5% of net ampere-hour discharge between charge cycles.

In yet another embodiment, the system may further comprise a thermometer for sensing battery temperature. The thermometer may communicate with the regulator and/or to adjust a recharge constant voltage profile inversely with temperature. In embodiments wherein the battery comprises multiple individual energy canisters, a plurality of thermometers may be capable of sensing temperature of each energy canister. In one embodiment, the selected voltage limit is computed from: VperCell=V1-Tcoeff*(Btemp-20.degree. C.) where VperCell is the selected voltage limit per cell, V1 is an ideal per cell battery voltage, Tcoeff is a battery temperature coefficient in volts per cell per degree centigrade and Btemp is sensed battery temperature this information is then relayed into the vehicle smart computer/net metering system.

In a further embodiment, the smart computer apparatus of the vehicle has a display. The smart computer apparatus is configured to compute and display the battery state on the display.

In yet another embodiment, the vehicle may further comprise a continuity check circuit for disabling operation of a battery charging system upon detection of a vehicle issue.

In a further embodiment the system may be incorporated into a vehicle having an electrical motor and an electrically regenerative braking system wherein the motor operates as an electrical power generator. In this embodiment, the compensator may further comprise a sensor for sensing current supplied from the motor to the batteries as a function of time during regenerative braking. Another embodiment of the vehicle may include a vehicle having an internal combustion engine coupled to electric generating means for providing the vehicle with propulsion power at selected times and for controllably charging the battery, the electric/hybrid vehicle being selectively operative in an electrical braking mode wherein the motor operates as an electrical generator for returning power.

What is claimed is:

1. A solar powered battery charging system for a vehicle comprising:
a photovoltaic panel attached to an outer surface of the vehicle;
a battery apparatus located within the vehicle, and electrically connected to the photovoltaic panel; and
wherein the system is constructed and arranged to be added into the vehicle, wherein the vehicle is an existing, non-solar powered vehicle.

2. The solar powered battery charging system for a vehicle of claim 1 further comprising:
a regulator configured to provide a regulated voltage from the photovoltaic panel to the battery apparatus; and
a controller configured to control and optimize battery charging by the system.

3. The solar powered battery charging system for a vehicle of claim 2 wherein the regulated voltage is constant.

4. The solar powered battery charging system for a vehicle of claim 2 wherein the system further comprises a smart computer, the smart computer in electronic communication with the regulator and the controller.

5. The solar powered battery charging system for a vehicle of claim 4 wherein the smart computer is further configured to transfer an excess amount of energy from the photovoltaic panel to a utility company grid.

6. The solar powered battery charging system for a vehicle of claim 5 further comprising a high voltage direct current cable extendable from the vehicle and connectable to a socket, the cable and socket providing electronic communication between the photovoltaic panel attached to the vehicle and a utility company electronic grid.

7. The solar powered battery charging system for a vehicle of claim 1 wherein the photovoltaic panel is attached to a hood of the existing, non-solar powered vehicle.

8. The solar powered battery charging system for a vehicle of claim 1 wherein the battery apparatus further comprises a plurality of energy canisters, and wherein a smart computer transfers energy from the photovoltaic cell to each of the plurality of energy canisters via a plurality of direct current cables.

9. The solar powered battery charging system for a vehicle of claim 2 further comprising:
a thermometer, attached to the battery apparatus and in electronic communication with the controller, the controller configured to adjust the regulated voltage according to a temperature recorded by the thermometer; and
a sensor configured to record a number of occurrences of recharge of the battery apparatus and accumulated ampere-hours, the controller further configured to apply an equalizing charge to the battery after assembly after a predetermined number of recharge occurrences and accumulated ampere-hours since a last equalizing charge.

10. The solar powered battery charging system for a vehicle of claim 9 wherein the controller is configured to adjust the regulated voltage inversely with temperature.

11. The solar powered battery charging system for a vehicle of claim 9 wherein the controller is further configured to overcharge the battery apparatus.

12. A method of solar charging of a battery of a vehicle comprising the steps of:
installing a photovoltaic panel on an existing vehicle having a battery apparatus;
connecting the photovoltaic panel to the battery apparatus;
providing a regulated voltage to the battery apparatus from the photovoltaic panel using a regulator positioned on an electric path between the battery and the photovoltaic panel;
controlling an amount of ampere-hours for charging the battery apparatus using a controller.

13. The method of solar charging of a battery of a vehicle of claim 12 further comprising transferring an excess amount of energy from the photovoltaic panel to a utility company grid.

14. The method of solar charging of a battery of a vehicle of claim 13 further comprising extending an electronic cable from the vehicle, and connecting the cable to a socket, thereby providing electronic communication between the cable and a utility company grid.

15. The method of solar charging of a battery of a vehicle of claim 14 further comprising the steps of:
parking the vehicle;
charging the battery apparatus while parked; and
wherein the step of transferring an excess amount of energy is performed after the battery apparatus is fully charged.

16. The method of solar charging of a battery of a vehicle of claim 12 wherein the step of providing a regulated voltage comprises providing a constant voltage.

17. The method of solar charging of a battery of a vehicle of claim 12 further comprising:
recording a temperature of the battery apparatus;
adjusting the regulated voltage according to a temperature recorded by the thermometer;
recording a number of occurrences of recharge of the battery apparatus and accumulated ampere-hours; and
applying an equalizing charge to the battery after assembly after a predetermined number of recharge occurrences and accumulated ampere-hours since a last equalizing charge.

18. A kit for allowing solar battery charging of an existing vehicle having a battery apparatus, the kit comprising:
a photovoltaic panel constructed and arranged to be attached to an outer surface of an existing vehicle;
a quantity of cable for electronically connecting the photovoltaic panel to the battery apparatus;
a regulator for attachment along the electronic connection between the photovoltaic panel and the battery apparatus; the regulator configured to provide a constant voltage from the photovoltaic panel to the battery apparatus; and
a controller for attachment along the electronic connection between the photovoltaic panel and the battery apparatus; the controller configured to control and optimize battery apparatus charging by the kit; and
an instruction manual and schematic for configuring an on-board computer of the vehicle to receive the kit and for installing the kit on the vehicle.

19. The kit for allowing solar battery charging of an existing vehicle of claim 13 further comprising a quantity of cable configured to allow a transfer of an excess of amount of energy from the photovoltaic panel to a utility company grid.

20. The kit for allowing solar battery charging of an existing vehicle of claim 13 further comprising:
a thermometer, configured to be attached to the battery apparatus and in electronic communication with the controller, the controller configured to adjust a recharge voltage according to a temperature recorded by the thermometer; and
a sensor configured to record a number of occurrences of recharge of the battery apparatus and accumulated ampere-hours, the controller further configured to apply an equalizing charge to the battery from the photovoltaic panel after assembly after a predetermined number of recharge occurrences and accumulated ampere-hours since a last equalizing charge.
